(19) United States
(12) Patent Application Publication
(10) Pub. No.: US 2018/0195338 A1
(43) Pub. Date: Jul. 12, 2018

(54) CORNER CONNECTOR FOR INSULATING GLAZING UNITS

(71) Applicant: SAINT-GOBAIN GLASS FRANCE, Courbevoie (FR)

(72) Inventors: Katrin FRANK, LEONBERG (DE); Andreas NOSITSCHKA, AACHEN (DE); Wolfgang VON AVENARIUS, HERZOGENRATH (DE); Markus STAHL-BIDINGER, HEINSBERG (DE)

(21) Appl. No.: 15/741,266

(22) PCT Filed: Aug. 26, 2016
(86) PCT No.: PCT/EP2016/070139

§ 371 Date: Mar. 30, 2018

(30) Foreign Application Priority Data
Aug. 26, 2015 (EP) 15182521.3

(51) Int. Cl. E06B 3/667; E06B 3/663; E06B 3/673

(52) U.S. Cl. CPC E06B 3/667; E06B 3/66314; E06B 2003/6638; E06B 3/67321; E06B 3/67365; E06B 3/67308

(57) ABSTRACT

A corner connector for hollow-profile spacers of insulating glazing units is presented. The corner connector includes first and second legs, connected via a corner region, that include respective leg inner sides, leg outer sides, end faces, and a plurality of side faces. According to one aspect, the leg inner sides, the leg outer sides, and/or the side faces include at least one retaining element; the leg inner sides provide respective inner bearing faces having: inner regions adjacent the corner region, and outer regions adjacent the inner regions and the end faces. The inner bearing face of at least one of the leg inner sides has, in its inner region, a positive gradient starting from the corner region in the direction of its end face.

The invention relates to a corner connector for insulating glazing units, an insulating glazing unit with such a corner connector, a method for production thereof, and use thereof.

Insulating glazing units are made from at least two panes that are bonded to one another via at least one circumferential spacer. As a rule, these spacers are implemented as hollow-body profiles whose side faces rest against the panes, while the inner sides face in the direction of the interpane space. This interpane space referred to as the glazing interior is filled with air or gas, but, in any case, free of moisture. An excessively high content of moisture in the glazing interpane space results, particularly with cold outside temperatures, in condensation of water drops in the interpane space, which must absolutely be avoided. For absorption of the residual moisture remaining in the system after assembly, hollow-body spacers filled with a desiccant can, for example, be used.

Various hollow-body spacers made of polymeric or metallic materials are known in the prior art. For example, WO 2013/104507 A1 describes a polymeric hollow-body spacer with improved leak-tightness and insulating effect.

In the assembly of an insulating glazing unit, hollow-body spacers in the form of individual profiles, whose length varies according to the length of the insulating glazing unit to be produced, are used. These are joined together in the subsequent assembly step by means of plug-in connectors to form a hollow-profile frame. Such a modular structure enables high flexibility with regard to the size of the glazing to be produced. Plug-in connectors can be used both in the form of linear connectors on the glazing edges and as corner connectors. Diverse demands are made on such plug-in connectors in terms of the stability of the plug connection and in terms of fast production workflow. On the one hand, it must be ensured that the plug-in connectors can be applied in a simple manner in the production process; on the other, it must be guaranteed in the further handling of the profile frame that the plug-in connectors remain in the hollow-profile and do not slip out even under the effect of force.

DE 19850491 A1 discloses a metal connector for spacers that has locking elements that prevent the slipping of the plug-in connector out of the spacer profile.

More recent developments in the field of plug-in connectors are instead directed toward polymeric plug-in connectors that can be produced simply and economically by injection molding. In this context, EP 2281994 A2, EP 2066861 B1, and DE 202012103899 U1 are to be mentioned. A variety of technical improvements in this field relate primarily to the secure locking of the plug-in connector in the spacer by various retaining elements as well as the compensation of manufacturing tolerances of the spacer by the plug-in connector.

DE 38221 17 A1 discloses a corner connector for connecting hollow-profile spacers of insulating glazing units that has improved leak-tightness.

DE 84 19 558 U1 describes a corner angle for hollow-profile spacers that has two mutually pivotable legs such that the angle formed by the legs is freely adjustable.

WO 2012/139908 A1 discloses a corner angle for hollow-profile spacers of insulating glazing units, wherein the corner angle has two legs with, on the leg inner side in each case, an inner region with anchoring blades and an outer region with sealing blades. The inner region is adjacent the corner region of the corner angle. The height of the anchoring blades within the inner region is constant, while the height of the sealing blades within the outer region is likewise constant and the sealing blades have a greater height than the anchoring blades.

For producing an insulating glazing unit, first, a frame is preassembled from a plurality of spacers and plug-in connectors onto which, in the further process, a plurality of panes are applied. If a rectangular shape of the subsequent glazing unit is desired, which represents by far the most frequent geometrical shape, four spacer profiles are joined with four corner connectors to form a frame. In the further process steps, it must be guaranteed by an appropriate design of the corner connector that it remains in the spacer even during transport of the frame and does not slip out. Nevertheless, even with adequate locking of the corner connector, damage to the spacer can occur due to transport. In the case of manual handling of the frame, it is gripped by a production worker on two opposite edges and placed at an appropriate point in the production line. Even with careful handling, the opposite sides of the frames are pressed together and brought close to one another. The stresses created in the frames result in forces acting on the inner edge of the profile base of the spacer, which can break as a result. Such damaging of the spacer results, in case of doubt, in a failure of the insulating glazing unit and must thus absolutely be avoided.

The object of the invention is to provide a corner connector for hollow-profile spacers of insulating glazing units, which prevents damaging the spacer during transport of a preassembled spacer profile frame, an insulating glazing unit with such a corner connector, as well as a method for production thereof.

The object of the present invention is accomplished by a corner connector, an insulating glazing unit, a method for production thereof, and the use of the corner connector according to the independent claims 1, 12, 13, and 15. Preferred embodiments of the invention are apparent from the subclaims.

The corner connector according to the invention comprises at least a first leg and a second leg that are connected via a corner region, wherein the corner connector can be plugged into a hollow-profile spacer of insulating glazing units by means of the legs. The first and the second leg of the corner connector include in each case at least one leg inner side, which points, after assembly of the corner connector in an insulating glazing unit, in the direction of the profile base of the spacer and the glazing interior, and in each case at least one leg outer side, which points, in the assembled state, toward the profile top of the spacer and toward the outer interpane space. Furthermore, the corner connector has at least two end faces, which are directed, after plugging the leg into a hollow-profile spacer, into its hollow space, wherein the side faces of the corner connector rest against the side walls of the spacer. The leg inner sides, the leg outer sides, and/or the side faces of the corner connector include one or a plurality of retaining elements that prevent a sliding out of the corner connector after plugging into the hollow-body spacer. The number and positioning of the retaining elements is governed by their design and retaining force. The leg inner sides of the corner connector have in each case an inner bearing face, which, after insertion into a spacer, accommodates the profile base of the spacer. The bearing faces can be formed both directly by the leg inner side as well as indirectly by elements mounted on the leg inner side. The inner bearing faces are thus defined as the faces of the leg inner side that can come into contact at least partially with the profile base of a plugged-in hollow-profile spacer. The inner bearing surfaces can be formed either by a continuous connected surface or even by a discontinuous surface that consists of a plurality of adjacent individual segments. The inner bearing surfaces include an inner region adjacent the corner region and an outer region. The outer region connects to the inner region and is located between an inner region and an end face of the corner connector. The inner region of the corner connector has, starting from the corner region, a positive gradient in the direction of the end face of the associated leg. The bearing surface thus rises in the inner region of the leg inner side from the corner region in the direction of the outer region and the end face. The outer region can either also have a gradient or run parallel to the leg outer side.

Because of the fact that the inner region of the corner connector has, starting from the corner region, a positive gradient in the direction of the end face of the associated leg and the bearing surface thus rises in this inner region of the leg inner side from the corner region in the direction of the outer region and the end face, a hollow-profile spacer plugged into the corner connector does not rest directly against the corner connector in the inner region of the corner connector. The spacer makes contact with the plugged-in profile body via the leg outer sides, via the outer region of the leg inner side, and via the side faces. The inner region of the leg inner side does not touch the profile base of the spacer in the force-free state because of the progression of the gradient of the leg inner side according to the invention.

This is particularly advantageous, since a load effect on the open edge of the spacer is thus avoided and the force is directed into the interior of the hollow-profile spacer. During transport of a profile frame composed of a plurality of hollow-profile spacers and corner connectors, a force acts on the profile base of the spacer adjacent the corner region, particularly easily resulting in breakage of the profile base. The high flexibility of the preassembled profile frame makes reliable transport difficult. In the case of manual handling of the frame, the opposing edges are easily pressed together and bent inward. Due to the high leverage effect, minimal deformations suffice to cause damage to the spacer. The corner connector according to the invention prevents such damage to the profile frame, since according to the invention the introduction of force is occurs via one face. Even under the effect of force, the inner bearing face of the spacer does not rest against the profile base of the spacer in the inner region. Since the force is no longer introduced on the open edge of the spacer, breakage of the hollow-profile spacer is particularly advantageously avoided.

The legs of the corner connector can form any desired angle relative to one another. Preferably, the legs form an angle of 90° relative to one another such that this can be used in conventional glazing units with a basic rectangular shape. Preferably, the corner connector according to the invention has a rigid unchangeable corner angle. Thus, the typical disadvantages of corner connectors with mutually pivotable legs, such as loss of stability and lack of leak-tightness, are avoided.

In the outer region of the leg inner side, the inner bearing face can, depending on the embodiment, also have a gradient or also run parallel to the associated leg bottom.

In a first embodiment of the corner connector according to the invention, the leg inner sides have retaining elements. These retaining elements provide an inner bearing face for accommodating the profile base of a hollow-profile spacer. The profile base does not rest directly against the leg inner side, but, rather, against the inner bearing face formed by the retaining elements, which runs at a distance from the leg inner side. The inner bearing face is, in this case, discontinuous and is composed of the individual surfaces of the retaining elements.

The retaining elements on the leg inner sides comprise fins, wherein their length L decreases from the end face of the leg in the direction of the corner region. Thus, the course of the inner bearing face according to the invention develops, rising in the inner region of the leg inner side in the direction of the end face. Accordingly, in the inner region, the leg inner side has shorter fins that do not rest against the profile base of a plugged-in spacer. The already discussed positive gradient of the inner bearing surface in the inner region starting from the corner region in the direction of the end faces develops over the progression of the length of the fins in this inner region.

The length of the fins thus increases locally within the inner region of the inner bearing surface starting from the corner region. This is advantageous for providing a continuous bearing face. If a change in length of the fins occurred only at the transition from the inner region to the outer region of the inner bearing surface, a bearing edge would develop at this point, which favors breakage of a plugged-in spacer under the effect of force. The positive gradient of the inner bearing surface in the inner region prevents the creation of such a bearing edge.

If a preassembled profile frame consisting of four corner connectors and four hollow-profile spacers is now stressed by the effect of force on opposite edges of the profile frame, the load is distributed areally over the inner bearing face in the outer region of the leg inner side. This areal introduction of force prevents damaging the spacer. A prior art corner connector presents, at this location, breakage of the profile base of the spacer, since upon loading, a linear load acts on the open edge of the hollow-profile spacer.

The fins on the leg inner side of the corner connector in accordance with a first embodiment function, beyond the described effect, as retaining elements such that, moreover, no further retaining elements are necessary on the side faces or the leg outer sides. If further improved anchoring is desired, additional retaining elements can also be mounted, for example, on the side faces.

Moreover, the use of fins is advantageous since they particularly advantageously compensate manufacturing tolerances of the hollow-profile spacers. When a hollow-profile spacer is plugged into the corner connector according to a first embodiment according to the invention, the fins in the outer region of the leg inner side are deformed and rest against the profile base. By means of the deformation of the fins, it is possible to prevent, on the one hand, a slipping out of the corner connector and, on the other, a loss of desiccant from the hollow body of the spacer.

In the context of the invention, “fins” refers to spring elements attached on one end that are anchored on one side to the legs of the corner connector. These spring elements can swing freely at their unattached end and are deformable such that a force exerted by plugging in a hollow-profile results in deformation of the fins. In order to enable this necessary movability of the fins, there is no further restriction to movability, other than said one-sided attachment on the leg of the corner connector. There is no mutual connection of the fins among each other, no connection to any reinforcing ribs or other elements that might exist. The fins according to the invention are, moreover, inclined in the direction of the corner region of the corner connector. This orientation facilitates, on the one hand, the plugging in of a hollow-profile in the direction of the inclination direction of the fins, while making the removal of a hollow-profile against the inclination direction of the fins difficult. Preferably, the fins form an angle of 10° to 70°, particularly preferably 20° to 50° relative to the surface of the leg from which they emerge.

The progression of the gradient of the inner bearing surface described for the inner region of the leg inner side can be either continuous or discontinuous. In a preferred embodiment, the positive gradient of the bearing surfaces in the inner region of the leg inner side presents a continuous progression. This is advantageous for providing the flattest possible bearing face for a plugged-in hollow-profile. The gradient can either have a constant progression between the corner region and the transition from the inner region to the outer region of the inner bearing surface or an asymptotic progression. An asymptotic progression has the advantage that adaptation to the stiffness or the deformation of the hollow profile which occurs is possible and a load peak at the transition between the inner region and the outer region of the inner bearing surface is avoided.

Preferably, the inner bearing faces of the corner connector according to the invention form, in the inner region, an angle α of 0.5° to 15°, preferably of 1° to 10°, particularly preferably of 2° to 7° relative to the leg outer side of the same leg. Even a slight slope of the inner bearing surface in the direction of the corner region is, accordingly, adequate for avoiding breakage of the spacer through the effect of force on the profile frame.

Preferably, the following applies for the length L₁ of the longest fin of the outer region and the length L₂ of the shortest fin of the inner region: I=L₁/L₂ with 4≥I≥1,5

Such a length ratio of the fins has proven particularly advantageous for avoiding damage to the hollow-profile spacer.

The fins usually have a length of 0.5 mm to 10 mm, preferably 1 mm to 7 mm, particularly preferably 1 mm to 5 mm.

In a possible embodiment, the length L of the fins on the leg inner sides decreases continuously starting from the end face in the direction of the corner region. The inner bearing face accordingly has, in the outer region and in the inner region of the leg inner side, the same gradient. The locking on the profile base of the hollow-profile spacer is done via the longest fins of the leg inner side, which are situated adjacent the end face. Thus, a point-wise introduction of force occurs via the longest fins of the leg inner side. The point at which the force is introduced is situated, however, at the maximum possible distance from the open edge of the hollow-profile spacer, by which means the risk of breakage on this open edge is reduced. Moreover, with increasing loading, the contact surface increases advantageously, since the share of the profile base that rests against the bearing surface increases.

Optionally, reinforcing ribs are applied on the leg inner sides and/or the leg outer sides. These advantageously increase the mechanical stability of the corner connector. Moreover, they form an additional barrier that prevents a loss of desiccant from the hollow space of the spacer.

In another possible embodiment of the invention, the gradient of the inner bearing surface changes from the inner region to the outer region. For example, the inner bearing face first increases in the inner region and then runs parallel to the leg outer side of the leg in the outer region. This large-area flat bearing face in the outer region is particularly advantageous in terms of ideal areal force distribution and firm anchoring of the corner connector.

In a second alternative embodiment of the corner connector according to the invention, the leg inner sides have no retaining elements. Thus, the inner bearing faces are formed by the leg inner sides themselves and constitute a continuous surface. The leg inner sides form a planar surface without fins or other retaining elements, as a result of which the corner connector according to the second embodiment can be produced in a simple manner by injection molding. In this embodiment as well, the inner bearing face has a positive gradient in the direction of the end face of the associated leg. The ramp thus formed declining in the direction of the corner region prevents breakage of the spacer frame due to loading. The gradient of the inner bearing surface can either change from the inner region to the outer region or remain constant.

Preferably, the inner bearing face in the outer region runs parallel to the leg outer side. This large-area flat bearing face in the outer region is particularly advantageous in terms of ideal areal force distribution and firm anchoring of the corner connector.

According to the second alternative embodiment of the invention, the legs are preferably formed from a monolithic material and have, in each case, a negative gradient adjacent the corner region. The thickness of the legs, corresponding to the height of the side faces, decreases from the end face of the corner connector in the direction of the corner region, with the aforementioned negative gradient thus developing. The monolithic shaping contributes to the stability and the simple producability of the corner connector. The negative gradient forms a ramp starting from the corner region and rising in the direction of the end faces, which, according to the invention, prevents breakage on the open edge of the spacer.

The corner connector according to the second embodiment, optionally includes at least one hollow chamber that extends along the leg. This hollow chamber increases the flexibility of the leg such that improved acceptance relative to manufacturing tolerances of the hollow-profile spacer occurs. The hollow chamber extends below the outer region of the leg inner side and preferably projects into a maximum of 50% of the inner region, based on the overall length of the inner region. The region of the leg directly adjacent the corner region with a length of at least 50% of the inner region has, in contrast, no hollow chamber. Instead of one hollow chamber, any number of hollow chambers can also be introduced, which increases, however, the complexity and thus the production costs of the component.

In both the first and the second preferred embodiment of the corner connector, the proportion of the inner region to the total length of the leg inner side is preferably between 10% and 70%, particularly preferably between 20% and 50%.

Preferably, the leg outer sides and/or the side faces of the corner connector according to the invention include at least one retaining element in the form of fins and/or in the form of a wire. The locking of the corner connector in the hollow-profile spacer is improved by an additional retaining element. The use of fins as retaining elements is advantageous since they are deformable and thus compensate the manufacturing tolerances of the spacer. A retaining element in the form of a wire can be obtained, for example, by inserting a wire into the injection mold at the time of production of the corner connector. The ends of the wire extend beyond the main body of the corner connector and protrude, after plugging in of a hollow-profile spacer, into its main body. Retaining elements in wire form thus enable very good locking of the corner connector in the spacer such that only a single retaining element in wire form is needed for adequate anchoring of the corner connector.

In conjunction with the second preferred embodiment, the use of a single retaining element in wire form is particularly preferred since the main body of the corner connector thus acquires simple geometry, which is readily realizable by injection molding. At the same time, very good locking of the corner connector can be ensured by means of the retaining element in wire form.

Alternatively, the leg outer sides and side faces can also include no further retaining elements, provided the leg inner sides already include fins in accordance with the first preferred embodiment of the invention.

Both in the first preferred embodiment and in the second preferred embodiment of the corner connector according to the invention, the bearing surface situated on the leg outer side has a gradient of 0° to 15°, preferably 1° to 10°, particularly preferably 2° to 7°. A gradient of 0° is advantageous for improving the contact area between corner connectors and hollow-profile spacers, and, thus, the locking of the corner connector. However, a rise in the bearing faces of the leg outer side is reasonable in terms of a further reduction in the risk of breakage of the hollow-profile spacer in the production process. As already discussed in detail, breakage of the spacer occurs primarily on the profile base. However, occasionally, damage is also noted on the profile top, which is avoided by means of a positive gradient of the bearing face of the leg outer side from the corner region in the direction of the end face. In the production process, two spacers are first put together via a corner connector, resulting in an L-shaped fragment of a profile frame. During assembly of additional corner connectors and spacers, it happens that the two legs of the L-shaped fragment are bent outward. At this point in the production process, damage to the profile base can also develop. This is avoided by a positive gradient of the bearing face of the leg outer side from the corner region in the direction of the end face.

The length of the leg inner side between the corner region and the end face of the corner connector is between 20 mm and 40 mm, preferably between 25 mm and 35 mm. The width of the leg inner side is highly variable, since this is directly related to the width of the hollow-profile spacers used and these are available in a large variety of dimensions. The width of the leg inner side, measured from one side face to the opposite side face, is 1 mm to 60 mm, preferably 2 mm to 50 mm, particularly preferably 4 mm to 4.5 mm. By way of example, possible widths of the leg inner side of 4 mm, 6 mm, 8 mm, 10 mm, 12 mm, 13 mm, 14 mm, 16 mm, 18 mm, 20 mm, 22 mm, 25 mm, 30 mm, and 34 mm can be mentioned. Retaining elements possibly mounted on the side faces, which likewise contribute to the overall width of the corner connector, are not taken into account in this listing. The length and width of the the leg inner side of the corner connector used depends on the dimensions of the hollow-profile spacer used. As a rule, the height of the hollow space between the profile top and the profile base of the spacer is constant even with embodiments of different widths. A slight variation in the width of the spacer used can be compensated by fins on the side faces of the corner connector. The fins are flexible and adapt to different widths of the hollow space by stronger or weaker deformation.

The corner connector according to the invention preferably contains biocomposites, polyethylene (PE), polycarbonates (PC), polypropylene (PP), polystyrene, polybutadiene, polynitriles, polyesters, polyurethanes, polymethylmethacrylates, polyacrylates, polyamides (PA), polyethylene terephthalate (PET), polybutylene terephthalate (PBT), polyvinyl chloride (PVC), particularly preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC and/or copolymers or mixtures thereof. These polymers can be processed very well in injection molding, yielding simple producability of the corner connector. In addition, polymeric materials have low thermal conductivity, resulting in improved thermal insulating properties of the profile frame assembled from corner connectors and spacers.

In a possible embodiment, the polymeric corner connector is fiber-reinforced. The corner connector preferably has a fiber content of 5% to 60%, particularly preferably of 20% to 50%. The fiber content in the corner connector according to the invention improves strength and stability. Through the selection of the fiber content, the coefficient of thermal expansion of the corner connector can be varied and adapted to the hollow-profile spacer. Preferably, natural fibers or glass fibers, particularly preferably glass fibers, are used for reinforcement of the corner connector.

The corner connector according to the invention can be implemented both as a single and as a multiple corner connector. A single corner connector includes two legs, each to accommodate one hollow profile spacer. A multiple corner connector has, in contrast, at least four legs, half of which run parallel to one another. In the corner region, the multiple corner connector has a web from which all legs of the corner connector emanate. In a preferred embodiment, the corner connector according to the invention is implemented as a double corner connector. It has four legs, of which two, respectively, are arranged parallel to one another. Such a double corner connector can be realized both in the first preferred embodiment and in the second preferred embodiment.

The invention further includes an insulating glazing unit with a corner connector according to the invention. The insulating glazing unit comprises at least two panes, at least one hollow-profile spacer, and at least one secondary sealant, wherein the ends of the hollow-profile spacer (open edges) are connected via corner connectors to form a profile frame. The panes are mounted on this profile frame and the outer interpane space formed by the panes and the hollow-profile spacer is at least partially filled with the secondary sealant.

The hollow-profile spacer comprises at least one hollow-profile with a first side wall, a second side wall arranged parallel thereto, a profile base, a profile top, and a hollow space. The hollow space is surrounded by the side walls, the profile top, and the profile base. The profile base forms the glazing interior wall of the spacer directed toward the inner interpane space of the insulating glazing unit. The side walls are the walls of the hollow-profile spacer, on which the panes of the insulating glazing unit are mounted. The first side wall and the second side wall run parallel to one another. The profile top runs at least partially parallel to the profile base and an points, after assembly of the insulating glazing unit toward the outer interpane space. However, the section of the profile top nearest the sidewalls can be inclined at an angle of preferably 30° to 60° in the direction of the side walls. This angled geometry improves the stability of the hollow-profile spacer.

The hollow space of the spacer according to the invention yields a weight reduction compared to a solidly molded spacer and is used during assembly of the profile frame to accommodate the corner connector according to the invention.

The hollow-profile spacer is preferably implemented as a rigid hollow profile. Various materials are suitable, such as metals, polymers, fiber-reinforced polymers, or wood. Metals are characterized by high gas and vapor tightness, but have high thermal conductivity. This results in the formation of a thermal bridge in the area of the edge seal, which results, with cold outdoor temperatures, in accumulation of condensation on the glass pane facing the building interior. This problem can be avoided through the use of materials with low thermal conductivity. Such spacers are referred to as “warm edge” spacers. However, these materials with low thermal conductivity often have poorer properties with regard to gas and vapor tightness.

In a preferred embodiment, a gas- and vapor-tight barrier is applied on the profile top and part of the side walls. The gas- and vapor-tight barrier improves the leak-tightness of the spacer against gas loss and penetration of moisture. Preferably, the barrier is implemented as a film. This barrier film includes at least one polymeric layer as well as one metallic layer or a ceramic layer. The layer thickness of the polymeric layer is between 5 μm and 80 μm, whereas metallic layers and/or ceramic layers with a thickness of 10 nm to 200 nm are used. Within the layer thicknesses mentioned, a particularly good leak-tightness of the barrier film is obtained.

Particularly preferably, the barrier film includes at least two metallic layers and/or ceramic layers, which are arranged alternatingly with at least one polymeric layer. Preferably, the outward lying layers are formed by the polymeric layer. The alternating layers of the barrier film can be bonded to one another or applied on one another in various methods known in the prior art. Methods for depositing metallic or ceramic layers are well known to the person skilled in the art. The use of a barrier film with an alternating layer sequence is particularly advantageous in terms of the leak-tightness of the system. A defect in one of the layers does not result in a loss of function of the barrier film. By comparison, in the case of a single layer, one small defect can already result in a complete failure. Furthermore, the application of multiple thin layers is advantageous compared to a thick layer since with increasing layer thicknesses, the risk of internal adhesion problems increases. Also, thicker layers have higher conductivity such that such a film is less suitable thermodynamically.

The polymeric layer of the film preferably includes polyethylene terephthalate, ethylene vinyl alcohol, polyvinylidene chloride, polyamides, polyethylene, polypropylene, silicones, acrylonitriles, polyacrylates, polymethyl acrylates, and/or copolymers or mixtures thereof. The metallic layer preferably includes iron, aluminum, silver, copper, gold, chromium, and/or alloys or oxides thereof. The ceramic layer of the film preferably includes silicon oxides and/or silicon nitrides.

The film preferably has gas permeation less than 0.001 g/(m²h).

In an alternative preferred embodiment, the gas- and vapor-tight barrier is implemented as a coating. This barrier coating contains aluminum, aluminum oxides, and/or silicon oxides and is preferably applied by a PVD method (physical vapor deposition). The coating containing aluminum, aluminum oxides, and/or silicon oxides delivers particularly good results in terms of leak-tightness and, in addition, presents excellent adhesion properties relative to the secondary sealants used in insulating glazing units.

Preferably, the hollow-profile spacer is made from polymers since these have low thermal conductivity, resulting in improved thermal insulating properties of the edge seal. Particularly preferably, the spacer contains biocomposites, polyethylene (PE), polycarbonates (PC), polypropylene (PP), polystyrene, polybutadiene, polynitriles, polyesters, polyurethanes, polymethylmethacrylates, polyacrylates, polyamides, polyethylene terephthalate (PET), polybutylene terephthalate (PBT), polyvinyl chloride (PVC), particularly preferably acrylonitrile butadiene styrene (ABS), acrylonitrile styrene acrylester (ASA), acrylonitrile butadiene styrene/polycarbonate(ABS/PC), styrene acrylonitrile (SAN), PET/PC, PBT/PC and/or copolymers or mixtures thereof.

Preferably, the hollow-profile spacer contains polymers and is glass-fiber-reinforced. The spacer preferably has a glass fiber content of 20% to 50%, particularly preferably of 30% to 40%. The glass fiber content in the polymeric spacer improves strength and stability. Through the selection of the glass fiber content in the spacer, the coefficient of thermal expansion can be varied and adapted. By means of adaptation of the coefficient of thermal expansion of the spacer and of the barrier film or barrier coating, temperature-related stresses between the different materials and flaking of the barrier film or the barrier coating can be avoided.

The hollow-profile spacer preferably has, along the profile base, a width of 5 mm to 45 mm, preferably of 10 mm to 20 mm. In the context of the invention, the width is the dimension extending between the side walls. The width is the distance between the surfaces of the two side walls facing away from one another. The distance between the panes of the insulating glazing unit is determined by the selection of the width of the profile base.

The hollow-profile spacer preferably has, along the side walls, a height of 5 mm to 15 mm, particularly preferably of 5 mm to 10 mm. In this range, the spacer has advantageous stability, but is, on the other hand, advantageously inconspicuous in the insulating glazing unit. Moreover, the hollow space of the spacer has an advantageous size for accommodating a suitable amount of desiccant. The height is the distance between the surfaces of the profile base end of the profile top facing away from each other.

The wall thickness d of the hollow-profile spacer is 0.5 mm to 15 mm, preferably 0.5 mm to 10 mm, particularly preferably 0.7 mm to 1.2 mm.

Preferably, the hollow space is filled with a desiccant. Preferably used as a desiccant are silica gels, molecular sieves, CaCl₂, Na₂SO₄, activated carbon, silicates, bentonites, zeolites, and/or mixtures thereof. The corner connector according to the invention reliably closes the hollow space on the open edge of the spacer such that a loss of desiccant is prevented. In this regard, the use of corner connectors with fins is advantageous since they effect very good sealing of the hollow space.

In a preferred embodiment, the the profile base has at least one opening. Preferably, a plurality of openings are made in the profile base. The total number of openings depends on the size of the insulating glazing unit. The openings connect the hollow space to the inner interpane space, making a gas exchange between them possible. Thus, absorption of atmospheric moisture by a desiccant situated in the hollow chambers is permitted and, hence, fogging of the panes is prevented. The openings are preferably implemented as slits, particularly preferably as slits with a width of 0.2 mm and a length of 2 mm. The slits ensure optimum air exchange without the desiccant being able to penetrate out of the hollow chamber into the interpane space.

In principle, various geometries of the insulating glazing unit are possible, for example, rectangular, trapezoidal, and rounded shapes. To produce round geometries, the hollow-profile spacer can be bent, for example, in the heated state.

The panes of the insulating glazing unit are mounted on the side walls of the spacer via a primary sealant. The first pane and the second pane are arranged parallel and congruently. The edges of the two panes are, consequently, arranged flush in the edge region. The inner interpane space is delimited by the first and second pane and the profile base. The outer interpane space is defined as the space that is delimited by the two panes and the profile top of the spacer. The outer interpane space is filled with a secondary sealant. A plastic sealing compound, for example, is used as the secondary sealant. The secondary sealant contributes to the mechanical stability of the insulating glazing unit and absorbs part of the climatic loads that act on the edge seal.

Preferably, the secondary sealant contains polymers or silane-modified polymers, particularly preferably organic polysulfides, silicones, room-temperature vulcanizing (RTV) silicone rubber, peroxide vulcanizing silicone rubber, and/or addition vulcanizing silicone rubber, polyurethanes, and/or butyl rubber. These sealants have a particularly good stabilizing effect.

The primary sealant preferably contains a polyisobutylene. The polyisobutylene can be a cross-linking or a non-cross-linking polyisobutylene.

The first pane and the second pane of the insulating glazing unit preferably contain glass and/or polymers, particularly preferably quartz glass, borosilicate glass, soda lime glass, polymethylmethacrylate, and/or mixtures thereof.

The first pane and the second pane have a thickness of 2 mm to 50 mm, preferably 3 mm to 16 mm, with the two panes also possibly having different thicknesses.

The insulating glazing unit according to the invention is preferably filled with a protective gas, particularly preferably with a noble gas, preferably, argon or krypton, which reduce the heat transfer value in the insulating glazing unit interspace.

In another embodiment, the insulating glazing unit includes more than two panes. In that case, the spacer can, for example, contain grooves into which at least one additional pane is arranged. The grooves divide the hollow space of the spacer into multiple hollow spaces. A spacer for a triple insulating glazing unit thus includes, for example, one pane in each case on the opposite side walls of the spacer and another pane in a groove between the first two panes. The groove isolates two hollow spaces of the spacer from one another. In this case, two individual corner connectors that can be inserted in each case into one of the hollow spaces can be used for the assembly of a profile frame. Preferably, however, a multi-corner connector is used since it can be inserted in a single process step into both hollow spaces and thus enables an efficient production process.

The present invention further includes a method for producing the insulating glazing unit according to the invention. In a first step, a profile frame is made from at least one corner connector and at least one hollow-profile spacer, wherein the corner connectors according to the invention are plugged into the open edges of the hollow-profile spacer. The corner connector according to the invention prevents damaging the preassembled profile frame during the subsequent assembly of the panes. Even with manual transport of large profile frames, the corner connector according to the invention prevents breakage of the profile base on the open edge of the spacer. In a second step of the method, this preassembled profile frame is mounted between two panes, with the side walls of the hollow-profile spacer being bonded to the panes via a primary sealant. Subsequently, in a third process step, a secondary sealant is introduced into the outer interpane space that is delimited by the panes and the profile top of the spacer.

Optionally, after the second process step, additional profile frames and additional panes are mounted, by which means, for example, triple or quadruple insulating glazing units can be obtained.

Optionally, the hollow-profile spacers used are multiple spacers that have one or a plurality of grooves for accommodating additional panes. These are preferably connected, in the first process step, via multi-corner connectors. In the first process step or in the second process step, additional panes are inserted into the grooves of the spacer.

The invention further relates to a method for producing a corner connector according to the invention by injection molding. In a first step, the raw material desired for the corner connector is prepared, for example, in the form of a plastic granulate. If fiber reinforcement of the corner connector is provided, these fibers are preferably already contained in the granulate. Alternatively, they can be added in the second process step. In the second process step, the raw material is plasticized in a plastic injection molding machine and, in a third process step, is injected under pressure into an injection mold, whose cavity corresponds to the shape of the component to be produced. The fourth process step includes the curing and cooling of the component in the injection mold, before the component is removed from the injection mold in a fifth process step.

Optionally, before the third process step, additional components to be overmolded can be inserted into the injection mold, for example, a retaining element in wire form.

The invention further relates to the use of a corner connector according to the invention as a corner angle of insulating glazing units. This includes all corner angles of insulating glazing units, for example, even inside corners of windows with glazing bars.

The invention is explained in detail in the following with reference to drawings. The drawings are purely schematic representations and are not true to scale. They in no way restrict the invention. They depict:

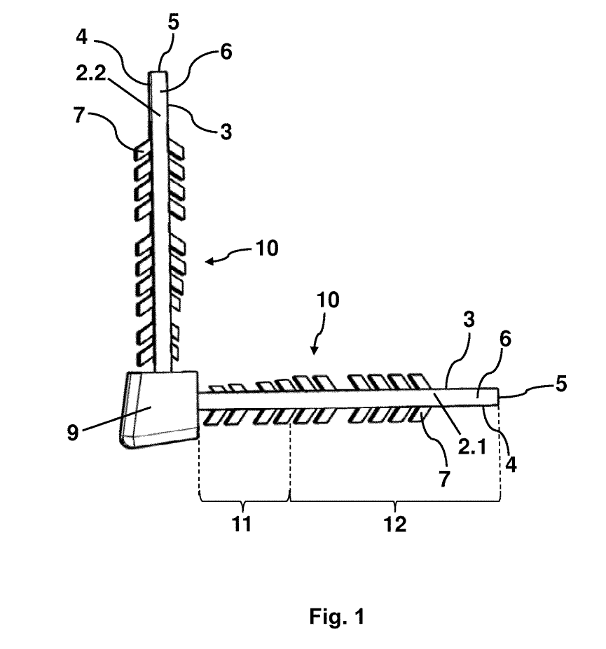

FIG. 1 a side view of a corner connector according to a first embodiment of the corner connector according to the invention,

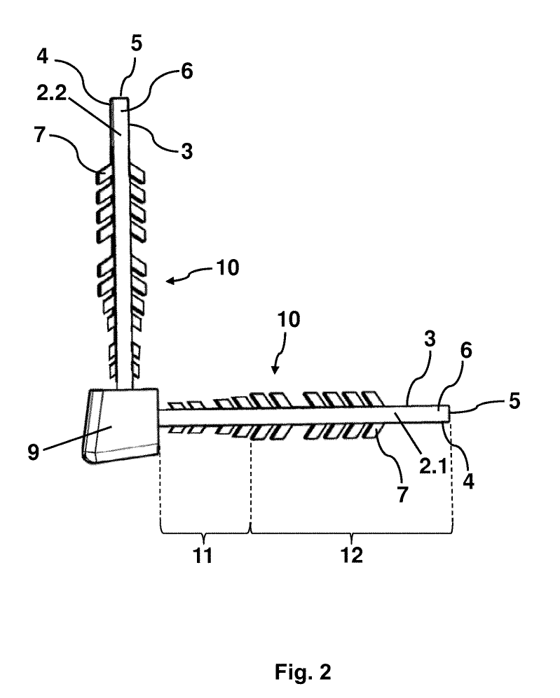

FIG. 2 a side view of another corner connector according to a first embodiment of the corner connector according to the invention,

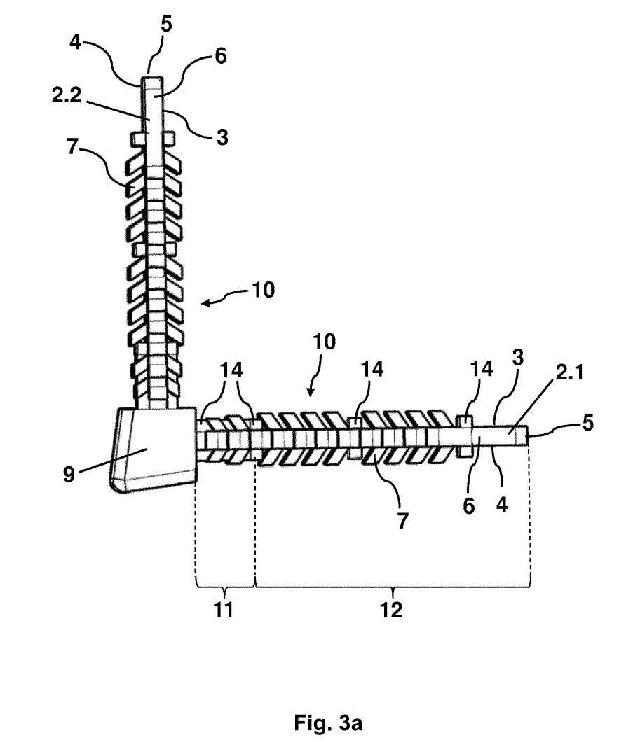

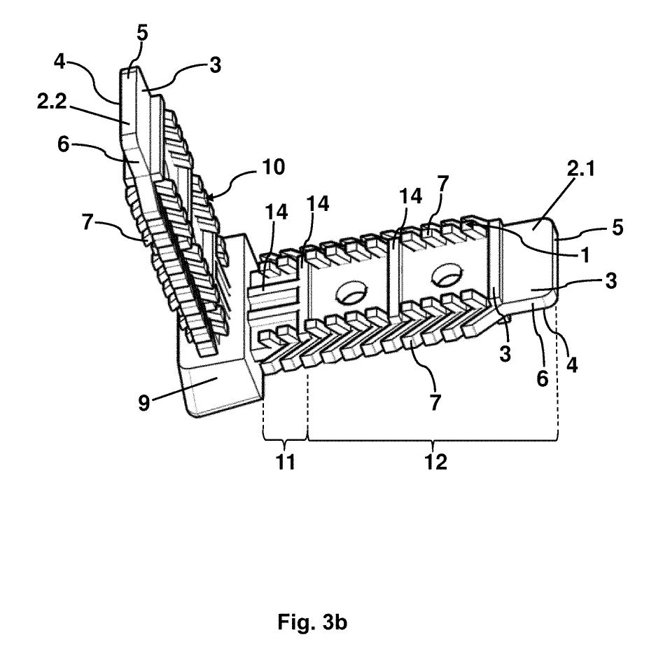

FIG. 3a, 3b a side view and a perspective view of another corner connector according to a first preferred embodiment of the corner connector according to the invention,

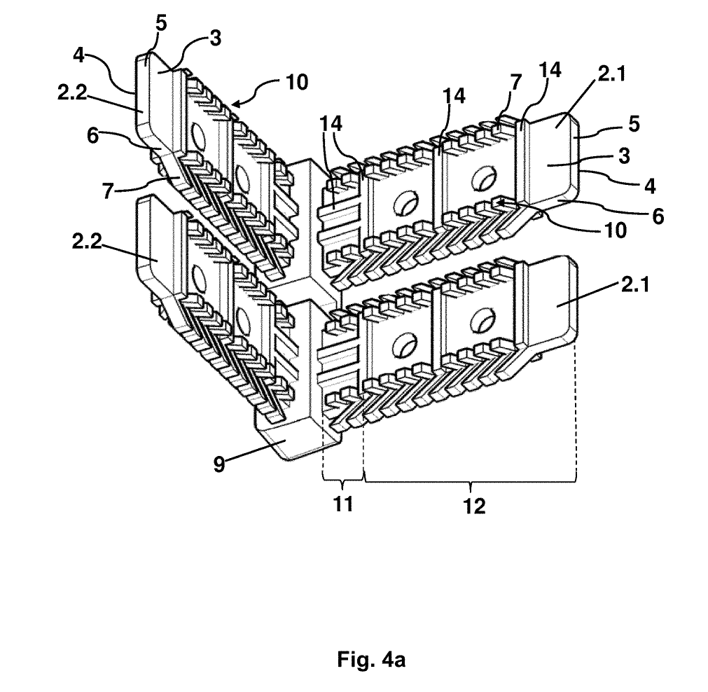

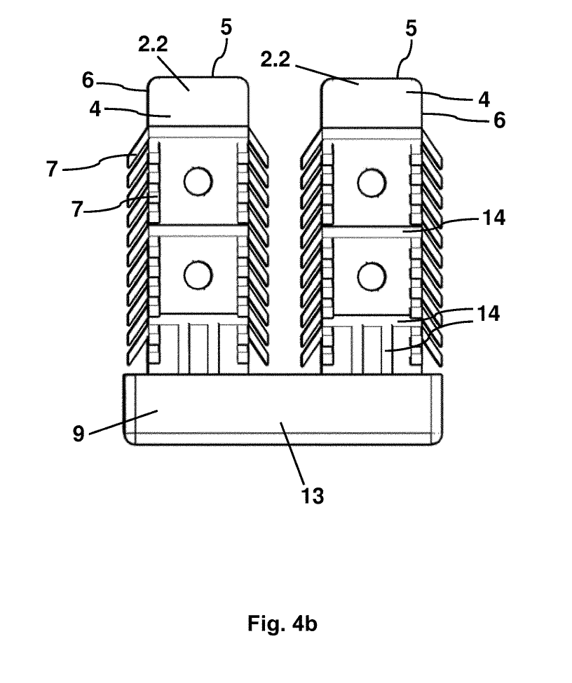

FIG. 4a, 4b a perspective view and a back view of a double corner connector according to a first embodiment of the corner connector according to the invention,

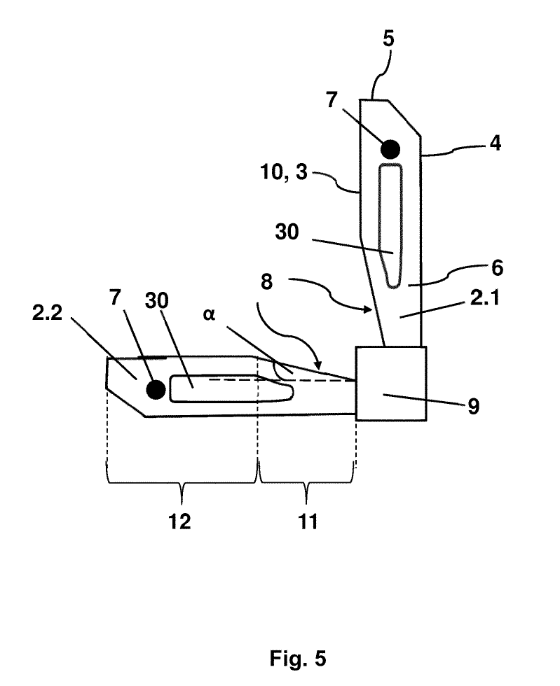

FIG. 5 a side view of a corner connector according to a second preferred embodiment of the corner connector according to the invention,

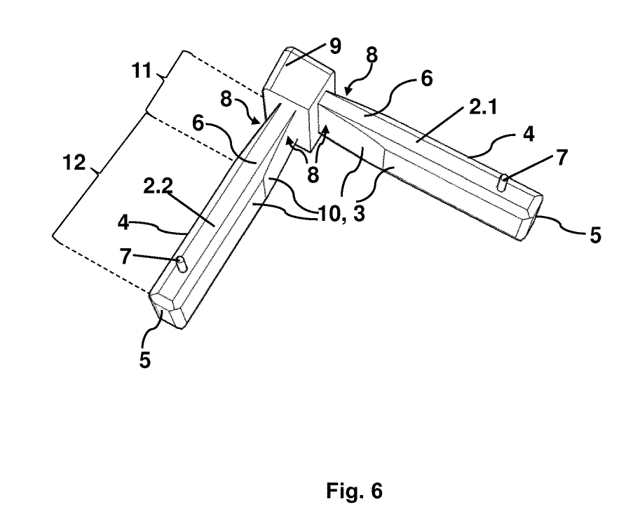

FIG. 6 a perspective view of an another corner connector according to a second preferred embodiment of the corner connector according to the invention,

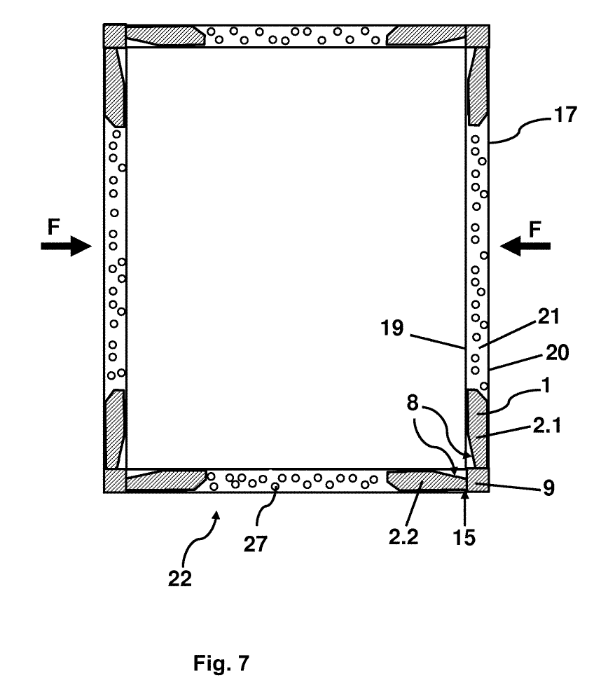

FIG. 7 a cross-section of a profile frame made up of four corner connectors according to FIG. 5 and four hollow-profile spacers,

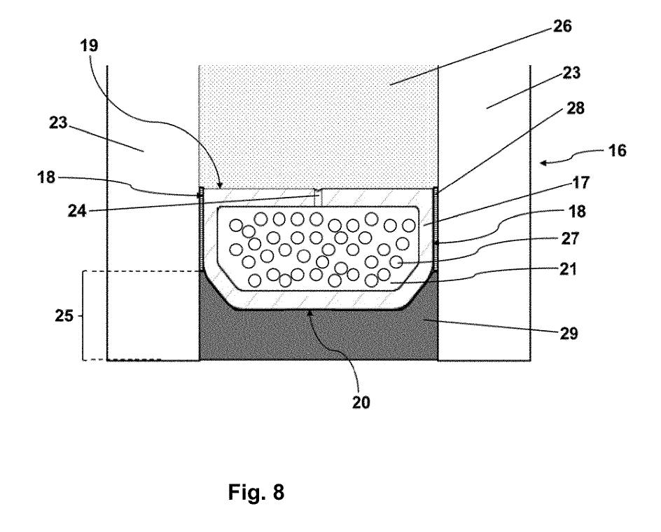

FIG. 8 a cross-section of an insulating glazing unit including a profile frame according to FIG. 7.

FIG. 1 depicts a side view of a corner connector according to a first preferred embodiment. The corner connector is made of polyamide with the glass fiber content of 25%. The corner connector comprises a first leg (2.1) and a second leg (2.2) that are connected via the corner region (9) and form an angle of 90° relative to one another. Each leg (2.1, 2.2) has in each case a leg outer side (4), a leg inner side (3), an end face (5), and two side faces (6). The leg inner sides have a length of 30 mm measured between the corner region (9) and the end face (5) and a width of 14 mm. The leg inner sides (3) are divided into an inner region (11) adjacent the corner region and and an outer region (12), which is situated between an inner region (11) and the end face (5). The inner region (11) has a length of 10 mm and the outer region (12) has a length of 20 mm. The leg inner sides (3) are equipped with retaining elements (7) in the form of fins, with the fins in the inner region region (11) shorter than the fins in the outer region (12) of the leg inner side (3). The surface of the fins forms an inner bearing face (10), which accommodates the profile base of the hollow-profile during assembly of a hollow-profile spacer. The fins in the inner region (11) have a length of 0.7 mm to 1.5 mm, with the shortest fin arranged adjacent the corner region (9) and the length of the fins increasing in the direction of the outer region (12). The fins of the outer region (12) have a constant length of 2 mm. The leg outer sides (4) are also equipped with fins as retaining elements (7) that have a constant length of 2 mm. Two rows of fins are mounted in each case on the leg inner sides (3) and the leg outer sides (4), with the back row of fins hidden by the front row in the side view depicted. The side faces (6) do not bear any retaining elements.

During assembly of a profile frame including the corner connector according to the invention of FIG. 1, surprisingly, no stress breakage of the profile base of the spacer occurs in the inner region (11) adjacent the corner region (9).

Compared to a prior art corner connector that is constructed analogously to the corner connector according to the invention but has, in contrast, fins of a constant length of 2 mm on the leg inner side (3), the proportion of stress breakage occurring can be reduced by approx. 30% using the corner connector of FIG. 1.

FIG. 2 depicts a side view of another corner connector in accordance with a first preferred embodiment of the corner connector according to the invention. The structure corresponds to the corner connector depicted in FIG. 1. In contrast thereto, the fins (7) have, in the inner region of the leg outer side (4), a length of 0.7 mm to 1.5 mm, with the shortest fins arranged adjacent the corner region (9) and the length of the fins increasing in the direction of the outer region (12). Thus, the fins on the leg inner side (3) are symmetrical to the fins mounted on the leg outer side (4). In this manner, damage to the profile top can be avoided during assembly of additional spacers on an already finished L-shaped fragment of a profile frame.

FIGS. 3a and 3b depict a side view and a perspective view of another corner connector in accordance with a first preferred embodiment of the corner connector according to the invention. The basic structure corresponds to the structure described in FIG. 2, with the fins on the leg inner side (3) and the leg outer side (4) in the outer region (12) having a length of 2 mm and in the inner region (11) having a variable length of 1.2 mm to 1.8 mm. The inner region (11) has a length of 0.6 cm and the outer region (12) has a length of 2.4 cm. The inner bearing face (10) formed by the surface of the fins thus has in the inner region (11) a positive gradient starting from the corner region in the direction of the outer region (12). Here as well, due to the progression of the inner bearing surface (10), a ramp declining in the direction of the corner region (9) develops, which avoids the stress breakage of a hollow-profile spacer plugged in on the corner connector. The side faces (6) of the corner connector likewise bear fins, which serve as additional retaining elements (7) and advantageously compensate manufacturing tolerances of the spacer. The fins of the side faces (6) have a length of 4 mm. Furthermore, the corner connector of FIGS. 3a and 3b has reinforcing ribs (14) that give the component higher rigidity and form an additional barrier for desiccant situated in the spacer.

FIGS. 4a and 4b depict a perspective view and a back view of a double corner connector in accordance with a first embodiment of the corner connector according to the invention. The structure corresponds substantially to the single corner connector described In FIGS. 3a and 3b, wherein the corner regions (9) of two individual corner connectors have a shared web (28) that connects them. The double corner connector of FIGS. 4a and 4b is particularly suited for assembly of double spacers for triple insulating glazing units. Thus, these can be plugged together to form a profile frame economically in terms of processing and, at the same time, precisely.

FIG. 5 depicts a side view of a corner connector in accordance with a second preferred embodiment of the corner connector according to the invention. The corner connector contains polyamide with a glass fiber content of 25%. The corner connector comprises a first leg (2.1) and a second leg (2.2) that are connected via the corner region (9) and form an angle of 90° relative to one another. Each leg (2.1, 2.2) has, in each case, a leg outer side (4), a leg inner side (3), an end face (5), and two side faces (6). The leg inner sides (3) have a length of 25 mm measured between the corner region (9) and the end face (5) and a width of 8 mm. The leg inner sides (3) are divided into an inner region (11) adjacent the corner region and an outer region (12), which is situated between the inner region (11) and the end face (5). The inner region (11) has a length of 9 mm and the outer region (12) has a length of 16 mm. The leg outer sides (4) and the leg inner sides (3) have no retaining elements at all. A retaining element (7) in the form of a wire is merely mounted in each case on the four side faces (6) of the corner connector. The wire has a diameter of 0.5 mm and protrudes in each case by 1 mm beyond the associated side face (6). Since retaining elements in wire form effect very good locking of the corner connector in the plugged-in spacer, further retaining elements are unnecessary. The legs (2.1, 2.2) are molded from a monolithic material and have, in each case, a negative gradient (8) adjacent the corner region. The inner bearing faces (10) correspond in this embodiment directly to the leg inner sides (3). The monolithic forming contributes to the stability and to the simple manufacturability of the corner connector. The negative gradient (8) forms a ramp starting from the corner region (9) and rising in the direction of the end faces. The gradient is, in the inner region (11) of the leg inner side (3), α=4°, by which means, here again, an inner bearing face (10) declining in the direction of the corner region develops.

The progression according to the invention of the inner bearing surface (11) results in the fact that, surprisingly, during assembly of a profile frame including the corner connector according to the invention of FIG. 5, no stress breakage of the profile base occurs.

In comparison, a profile frame with a prior art corner connector, which has no negative gradient in the inner region and otherwise has the same structure, has a number of stress breaks on the profile base greater by approx. 30%, compared to a corner connector in accordance with FIG. 5.

FIG. 6 depicts a perspective view of another corner connector in accordance with a second preferred embodiment of the corner connector according to the invention. The structure corresponds substantially to that described in FIG. 5, with the leg outer side (4) also having a negative gradient (8) in the inner region (11). Thus, the leg inner side (3) and the leg outer side (4) run symmetrically to one another. Additionally, for reducing the risk of breakage on the profile base of a plugged-in spacer, equivalent protection is also provided in the case of the profile top. During assembly of two spacers and a corner connector, an L-shaped fragment of a profile frame is obtained. With manual plugging-in of additional spacers and corner connectors by a production worker, a force effect on the profile base can be produced by the worker, causing bending of this L-shaped structure. With prior art corner connectors, this can result in damage to the profile tops that can be avoided by means of the corner connector in accordance with FIG. 6.

FIG. 7 depicts a profile frame consisting of four corner connectors in accordance with FIG. 5 and four hollow-profile spacers in cross-section. The legs (2.1, 2.2) of the corner connectors (1) are plugged in on the open edges (15) of the hollow-profile spacer (17) in its hollow space (21), yielding a rectangular profile frame (22). The corner region (9) of the corner connector (1) now forms the corner region of the profile frame (22), whereas the legs (2.1, 2.2) are completely plugged into the spacer and no longer visible from the outside. The profile top (20) of the hollow-profile spacer (17) forms the outer perimeter of the rectangle, while the profile base (19) defines the inner perimeter of the rectangle. The hollow space of the hollow-profile spacer (17) is filled with desiccant (27). During manual handling of the profile frame (22), the opposing edges of the frame are pressed together with a force F, as symbolized in FIG. 7 by arrows. The hollow-profile spacers (17) experience bending in the direction of the center of the frame, by which means a force acts on the profile base of the spacer adjacent the corner region of the corner connector. With the use of prior art corner connectors, this frequently results in breakage of the profile base (19) on the open edge (15). In the embodiment of the corner connector according to the invention of FIG. 7, such damage is prevented by a negative gradient (8) of the corner connector (1) in this region.

FIG. 8 depicts a cross-section of an insulating glazing unit (16) including a profile frame (22) according to FIG. 7. The hollow-profile spacer (17) is adhesively bonded by means of a primary sealant (28) between two glass panes (23). The primary sealant (28) is applied on the side walls (18) of the hollow-profile spacer (17). The panes (23) and the profile base (19) of the hollow-profile spacer (17) delimit an inner interpane space (26) of the insulating glazing unit (16). The panes (23) and the profile top (20) form an outer interpane space (25), which is filled with a secondary sealant (29). The hollow-profile spacer (17) includes a glass-fiber-reinforced polymeric main body, which contains styrene acrylonitrile(SAN) and approx. 35 wt-% glass fiber. The spacer has a hollow space (21). A desiccant (27), for example, a molecular sieve, is arranged inside the hollow space (21). This desiccant (27) can be filled into the hollow space (21) of the spacer before the assembly of the insulating glazing unit. The profile base (19) includes relatively small openings (24) or pores, which enable a gas exchange with the inner interpane space (26). The wall thickness of the hollow-profile spacer (17) is 1 mm, whereas the height of the hollow-profile spacer (17) is 6.5 mm. The width along the profile base (19) defines the distance between the panes (23) and is 12 mm.

During the assembly operation of the insulating glazing unit (16), damaging of the profile base (19) in the corner region of the profile frame is avoided by use of the corner connector according to the invention. The resultant insulating glazing unit (16) thus has, even in the corner region, a completely intact spacer such that better leak-tightness of the glazing unit is obtained.

### LIST OF REFERENCE CHARACTERS

(I) corner connector

(2) leg

(2.1) first leg

(2.2) second leg

(3) leg inner side

(4) leg outer side

(5) end faces

(6) side faces

(7) retaining elements

(8) negative gradient

(9) corner region

(10) inner bearing face

(11) Inner region

(12) outer region

(13) web

(14) reinforcing ribs

(15) open edge of the hollow-profile spacer

(16) insulating glazing unit

(17) hollow-profile spacer

(18) sidewalls of the hollow-profile spacer

(19) profile base

(20) profile top

(21) hollow space

(22) profile frame

(23) panes

(24) opening

(25) outer interpane space

(26) inner interpane space

(27) desiccant

(28) primary sealant

(29) secondary sealant

(30) hollow chamber

1.-10. (canceled)

11. A corner connector for hollow-profile spacers of insulating glazing units, the corner connector comprising:
a first leg and a second leg that are connected via a corner region, the first leg and second leg comprising respective leg inner sides, leg outer sides, end faces and a plurality of side faces, wherein:
one or more of the leg inner sides, the leg outer sides, and the plurality of side faces comprises at least one retaining element,
the leg inner sides provide respective inner bearing faces,
the inner bearing faces have respective inner regions adjacent the corner region,
the inner bearing faces have respective outer regions adjacent the respective inner regions and respective end faces,
the inner bearing face of at least one of the leg inner sides has, in the respective inner region, a positive gradient starting from the corner region in a direction of the respective end face,
the leg inner sides have retaining elements that form the respective inner bearing faces, and
the retaining elements on the leg inner sides comprise fins, whose length decrease from the respective end faces in a direction of the corner region.

12. The corner connector according to claim 11, wherein at least one of the inner bearing faces forms, in the respective inner region, an angle a relative to the respective leg outer side having a value in a range of 0.5° to 15°.

13. The corner connector according to claim 12, wherein the angle a has a value in a range of 1° to 10°.

14. The corner connector according to claim 12, wherein the angle a has a value in a range of 2° to 7°.

15. The corner connector according to claim 11, wherein a length L₁ of a longest fin of the respective outer regions of the leg inner sides, and a length L₂ of a shortest fin of the respective inner regions of the leg inner sides, are bound by: I=L₁/L₂ with 4≥I≥1.5.

16. The corner connector according to claim 11, wherein a proportion of the respective inner regions to the total length of the respective leg inner sides is between 15% and 70%.

17. The corner connector according to claim 11, wherein a proportion of the respective inner regions to the total length of the respective leg inner sides is between 20% and 50%.

18. The corner connector according to claim 11, wherein one or more of the leg outer sides and the side faces comprise at least one retaining element that is formed as a fin or as a wire.

19. The corner connector according to claim 11, wherein the corner connector contains one or more of: a) biocomposites, b) polyethylene (PE), c) polycarbonates (PC), d) polypropylene (PP), e) polystyrene, f) polybutadiene, g) polynitriles, h) polyesters, i) polyurethanes, j) polymethylmethacrylates, k) polyacrylates, I) polyamides (PA), m) polyethylene terephthalate (PET), n) polybutylene terephthalate (PBT), and o) polyvinyl chloride (PVC), preferably polyamides (PA), acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, particularly preferably polyamides, and/or copolymers or mixtures thereof.

20. The corner connector according to claim 11, wherein the corner connector contains one or more of: a) polyamides (PA), b) acrylonitrile butadiene styrene (ABS), c) acrylonitrile styrene acrylester (ASA), d) acrylonitrile butadiene styrene/polycarbonate (ABS/PC), d) styrene acrylonitrile (SAN), e) PET/PC, and f) PBT/P.

21. The corner connector according to claim 11, wherein the corner connector contains one or more of: a) polyamides, b) copolymers, and c) mixtures of a) and b).

22. An insulating glazing unit, comprising:
at least one corner connector according to claim 11;
at least two panes;
at least one hollow-profile spacer; and
at least one secondary sealant,
wherein
ends of the at least one hollow-profile spacer are connected via the at least one corner connector to form a profile frame,
the at least two panes are mounted on the profile frame, and
the at least one secondary sealant is introduced in an outer interpane space between the at least two panes adjacent the hollow-profile spacer.

23. A method for producing an insulating glazing unit, the method comprising:
a) forming a profile frame by connecting ends of at least one hollow-profile spacer via at least one corner connector;
b) mounting the profile frame between two panes; and
c) introducing at least one secondary sealant into an outer interpane space between the two panes adjacent the hollow-profile spacer,
wherein the at least one corner connector comprises a first leg and a second leg that are connected via a corner region, the first leg and second leg comprising respective leg inner sides, leg outer sides, end faces and a plurality of side faces,
wherein:
one or more of the leg inner sides, the leg outer sides, and the plurality of side faces, comprises at least one retaining element,
the leg inner sides provide respective inner bearing faces,
the inner bearing faces have respective inner regions adjacent the corner region,
the inner bearing faces have respective outer regions adjacent the respective inner regions and respective end faces,
the inner bearing face of at least one of the leg inner sides has, in the respective inner region, a positive gradient starting from the corner region in a direction of the respective end face,
the leg inner sides have retaining elements that form the respective inner bearing faces, and
the retaining elements on the leg inner sides comprise fins, whose length decrease from the respective end faces in a direction of the corner region.

24. A method for producing a corner connector, the method comprising:
a) preparing a plastic raw material;
b) plasticizing the plastic raw material in a plastic injection molding machine, thereby obtaining plasticized material;
c) injecting, under pressure, the plasticized material, into an injection mold;
d) leaving the plasticized material to cure in the injection mold; and
e) removing the corner connector from the injection mold,
wherein the corner connector comprises a first leg and a second leg that are connected via a corner region, the first leg and second leg comprising respective leg inner sides, leg outer sides, end faces and a plurality of side faces,
wherein:
one or more of the leg inner sides, the leg outer sides, and the plurality of side faces, comprises at least one retaining element,
the leg inner sides provide respective inner bearing faces,
the inner bearing faces have respective inner regions adjacent the corner region,
the inner bearing faces have respective outer regions adjacent the respective inner regions and respective end faces,
the inner bearing face of at least one of the leg inner sides has, in the respective inner region, a positive gradient starting from the corner region in a direction of the respective end face,
the leg inner sides have retaining elements that form the respective inner bearing faces, and
the retaining elements on the leg inner sides comprise fins, whose length decrease from the respective end faces in a direction of the corner region.

25. A method of using a corner connector, comprising:
providing a corner connector according to claim 1; and
using the corner connector in a insulating glazing unit.
